(19) United States
(12) Patent Application Publication
(10) Pub. No.: US 2011/0179299 A1
(43) Pub. Date: Jul. 21, 2011

(54) Power Management In A System Having A Processor And A Voltage Converter That Provide A Power Voltage To The Processor

(76) Inventors: Mark A Piwonka, Tombalt, TX (US); Louis B. Hobson, Tomball, TX (US); Robert C. Brooks, Houston, TX (US)

(21) Appl. No.: 13/120,652

(22) PCT Filed: Oct. 7, 2008
(86) PCT No.: PCT/US2008/079035

§ 371 Date: Mar. 23, 2011

(51) Int. Cl. G06F 1/32

(52) U.S. Cl. 713/323

(57) ABSTRACT

A system has a processor and a voltage converter to provide a power voltage to the processor. The processor is able to transition among different power modes, Wherein the voltage converter receives indications to specify different voltage levels of the power voltage for at least two of the power modes. A controller detects a transition of the processor to a tower one of the power modes, and in response to detecting transition of the processor to the lower one of the power modes, disables at least one portion of the voltage converter.

### BACKGROUND

A system, such as a computer, or any other type of electronic device, typically has various components that consume power. One of the components of a system that consumes a relatively large amount of power is a processor, such as a microprocessor, microcontroller, or any other control device that is used to perform the primary tasks of the system.

When a processor in a system is not active, it is desirable to place the processor into a lower power mode to achieve lower power consumption. For example, a processor can be associated with various power modes, including a number of performance states (states in which the processor is executing code but that are associated with different levels of power consumption) and a sleep or halt state (in which the processor is no longer executing code). Although transitioning the processor to different power modes depending upon the activity level of the processor can achieve power savings, there are usually other opportunities for power savings within a conventional system that are not exploited,

Government regulators of various jurisdictions have set requirements for power consumption levels when a system is idle (in other words, the system is not actively performing, any tasks). With conventional power savings techniques, many systems may not be able to meet the power-saving requirements set by some government regulators, particularly in jurisdictions in which the power-saving requirements have become increasingly stringent.

### BRIEF DESCRIPTION OF THE DRAWINGS

Some embodiments of the invention are described with respect to the following figures:

FIG. 1 is a block diagram of an exemplary system that incorporates an embodiment of the invention; and

FIG. 2 is a flow diagram of a power management process according to an embodiment.

### DETAILED DESCRIPTION

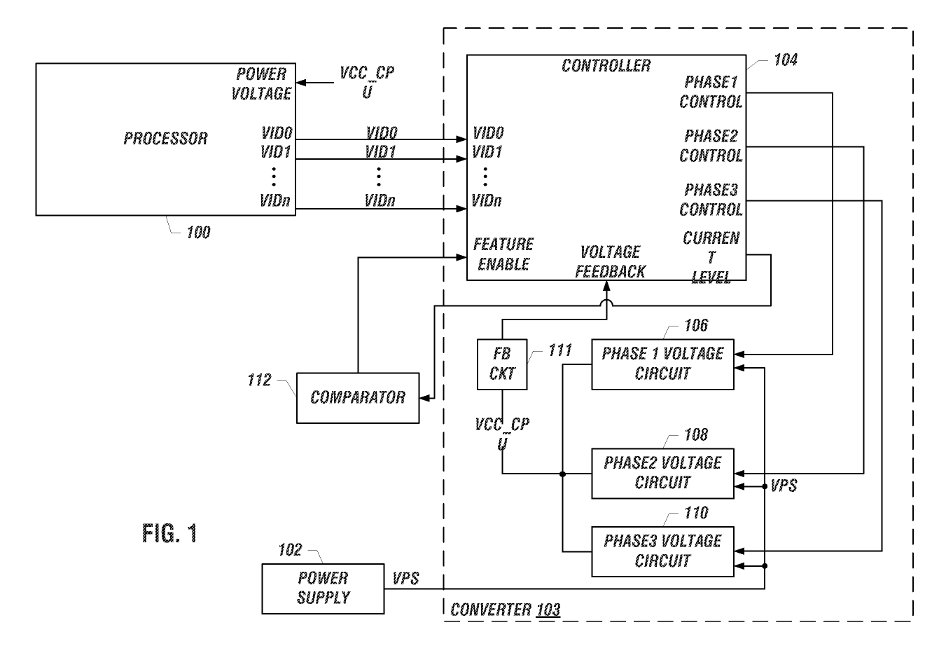

FIG. 1 illustrates an exemplary system that includes a processor 100, a power supply 102, and a power voltage converter 103 to convert an output voltage VPS of the power supply 102 to a power voltage (referred to as “VCC_CPU”) provided to a power voltage input of the processor 100. The power voltage VCC_CPU is the operating voltage (or one of the operating voltages used to enable the processor 100 to perform its tasks in the system.

In some embodiments, the processor 100 is associated with multiple power modes, including plural performance states and a sleep state (also referred to as a halt state). A “power mode” of a processor refers to a power consumption level of the processor—different power modes correspond to different levels of power consumption. A performance state of the processor 100 refers to an active state in which the processor 100 is capable of executing code (software instructions). The plural performance states of the processor 100 are associated with different amounts of power consumption. A “higher” performance state refers an active state associated with a higher power consumption than a “lower” performance state. The performance states include a “lowest” performance state (associated with a lowest amount of power consumption of the processor that is actively executing code), and one or more higher performance states (associated with higher power consumption levels). The lowest performance state is the performance state right above the sleep state in terms of power consumption).

In some implementations, the performance states of the processor 100 can be performance states as defined by the Advanced Configuration and Power interface Specification (ACPI). In other implementations, the term “performance state” can refer to any state of the processor 100 in which the processor is actively executing code.

In addition to the performance states, the power modes of the processor 100 also include asleep state (sometimes referred to as a halt state) in which the processor is not executing code. The sleep state is associated with a lower amount of power consumption than the lowest one of the performance states.

When the system detects that the processor has entered the sleep state, and that the current being drawn by the processor is below :predefined threshold, the system can disable portions of the converter 103 to achieve greater power savings than can be accomplished by merely placing the processor 100 into the sleep state. In accordance with some embodiments, to enable the system to properly detect that the processor is transitioning between different power modes (e.g., enter the sleep state or exit the sleep state), different voltage levels associated with the different power modes are defined for the power voltage (VCC_CPU) supplied to the processor 100. Indications are provided to the converter 103 to cause the voltage levels of VCC_CPU to change when the processor 100 transitions between different power modes (e.g., between the lowest performance state and the sleep state).

Moreover, in accordance with some embodiments, when the system detects that the processor has exited the sleep state (based on detecting the indications that specify a transition of the voltage level of VCC_CPU from the sleep state voltage level to the lowest performance state voltage level), the system can activate the portions of the converter 103 that were previously disabled due to the processor entering the sleep state. By activating the converter 103 portions (that were previously disabled) upon exiting the sleep state, the converter 103 can be fully activated in time for the expected power draw when the processor subsequently transitions to higher performance state(s).

As further depicted in FIG. 1, the converter 103 includes a controller 104 and voltage circuits 106, 108, and 110. Each of the voltage circuits 106, 108, and 110 is basically a DC-DC voltage converter to convert VPS to VCC_CPU. A feedback circuit 111 provides voltage feedback of VCC_CPU to the controller 104 to enable regulation of VCC_CPU at the desired level.

In some embodiments, the converter 103 is a multi-phase converter (a three-phase converter is depicted in FIG. 1, although other converters can use different numbers of phases, such as two or more than three phases). The three phases of the multi-phase converter 103 are provided by the three voltage circuits 106, 108, and 110. With the multi-phase converter 103 depicted in FIG. 1, different voltage circuits 106, 108, and 110 are switched on at different times. This reduces output current from the individual voltage circuits 106, 108, and 110.

As depicted in FIG. 1, the voltage circuit 106 is referred to as a “phase1” voltage circuit, the voltage circuit 108 is referred to as a “phase2” voltage circuit, and the voltage circuit 110 is referred to as “phase3” voltage circuit, The outputs of the voltage circuits 106, 108, and 110 are connected together to provide VCC_CPU. The inputs of the voltage circuits 106, 108, and 110 receive the power supply voltage VPS and also receive respective control signals from the controller 104. The control signals from the controller 104 include phase1 control signal(s) to control the phase1 voltage circuit 106, phase2 control signal(s) to control the phase2 voltage circuit 108, and phase3 control signal(s) to control the phase3 voltage circuit 110.

The phasex (x=1, 2, or 3) control signal(s) provided to a corresponding phasex voltage circuit (106, 108, or 110) can be active (to switch on the phasex voltage circuit), or inactive (to disable the phasex voltage circuit). The timing of the phase1, phase2, and phase3 control signals are controlled such that one or tore of the phase1, phase2, and phase3 voltage circuits 106, 108, and 110 are on at any time.

To disable any phasex voltage circuit, the phasex control signal(s) to that voltage circuit can be maintained inactive. As will be explained further below, in accordance with some embodiments, one or more of the phasex voltage circuits can be disabled to achieve further power savings when it is detected that the processor 100 has entered a low power mode (e.g., the sleep state), and it is detected that the current being drawn by the processor 100 is less than a predefined threshold. Disabling one or more phases of the phasex voltage circuits is also referred to as disabling or shedding phases of the multi-phase converter 103.

As noted above, in accordance with some embodiments, different VCC_CPU voltage levels are associated with at least the lowest performance state and the sleep state. In other words, a first VCC_CPU voltage level is associated with the lowest performance state, while a second, lower VCC_CPU voltage level is associated with the sleep state. This enables the controller 104 to distinguish between the lowest performance state and the sleep state of the processor 100.

In one implementation, the voltage level of VCC_CPU defined for the sleep state can be the minimum voltage level of the processor 100. The minimum voltage level for the power voltage to the processor 100 is the minimum level at which the processor 100 is able to maintain a context (e.g., data stored in registers and so forth) of the processor 100.

The other performance state(s) (other than the lowest performance state) of the processor 100 can be associated with one or more other voltage levels of VCC_CPU, where these other voltage level(s) is (are) higher than the voltage level of VCC_CPU for the lowest performance state. Alternatively, the other performance state(s) can be associated with the same VCC_CPU voltage level as the lowest performance state.

According to an embodiment, the processor 100 is programmed, such as with firmware (e.g., basic input/output system or BIOS firmware to set different voltage levels of VCC_CPU for the different power modes of the processor. The processor 100 can control the voltage level of VCC_CPU by outputting VID control signals VID0, VID1, and VIDn (where n≧2). The VID control signals are input to the controller 104 to control the voltage level of the output voltage VCC_CPU supplied by the output voltage circuits 106, 108, and 110. Thus, effectively, the VID control signals constitute one example of indications of different voltage levels for VCC_CPU for at least two of the power modes (e.g., sleep state and lowest performance state). The voltage level of VCC_CPU is changed by adjusting the phase1, phase2, and phase3 control signals output by the controller 104, such as by adjusting duty cycles of the phase1, phase2, and phase3 control signals.

The values of the VID control signals can thus be used by the controller 104 to determine whether the processor is entering or exiting the sleep state. A change in values of the VID control signals indicating a transition from VCC_CPU level associated with a performance state to asleep state VCC_CPU level indicates that the processor 100 has transitioned to the sleep state from a performance state. Alternatively, a change in values of the VID control signals indicating a transition from asleep state VCC_CPU level to a VCC_CPU level associated with a performance state indicates that the processor 100 is exiting the sleep state.

In accordance with some embodiments, a comparator 112 is provided for the purpose of determining whether or not an amount of current being drawn by the processor 100 from VCC_CPU (and more specifically, from the voltage circuits 106, 108, 110 that drive VCC_CPU) exceeds a predefined threshold. The current being drawn by the processor 100 from VCC_CPU is detected inside the controller 104. An output indication of the current drawn by the processor 100 from VCC_CPU is provided by the controller 104 as CURRENT LEVEL. The comparator 112 can be a circuit external to the controller 104, or alternatively, the comparator 112 can be part of the controller 104.

In response to the current drawn (CURRENT LEVEL) being less than the predefined threshold, the comparator 112 outputs a first indication (e.g., signal having an active state). In response to the current drawn exceeding the predefined threshold, the comparator 112 outputs a second indication (e.g., signal having an inactive state). The controller 104 has a FEATURE ENABLE input to receive the first or second indication. If the FEATURE ENABLE input receives the first indication, then the converter phase disabling feature is enabled, where the converter phase disabling feature refers to the controller 104 being able to disable phase(s) of the converter 103 in response to detecting that the processor 100 has transitioned to the sleep state. However, if the FEATURE ENABLE input receives the second indication, then the controller 104 is prevented from disabling the phase(s) of the converter 103 even if the processor 100 has entered the sleep state.

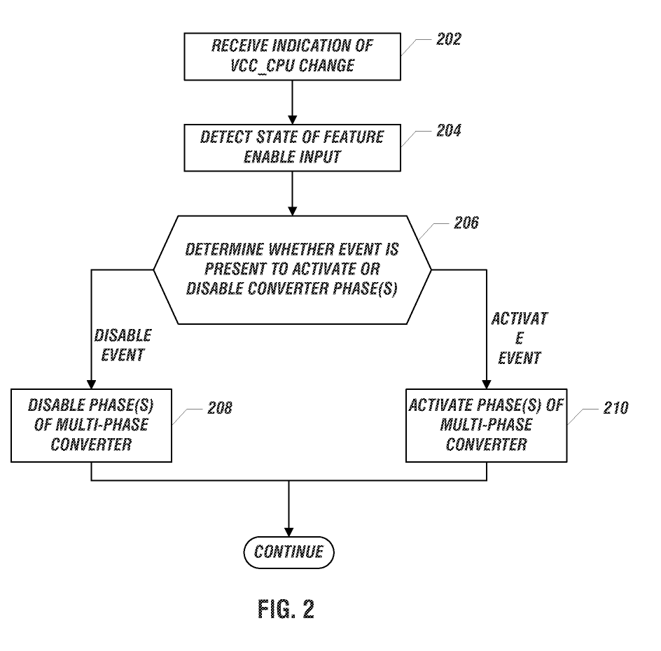

A process of performing power management by the controller 104 according to some embodiments is described in connection with FIG. 2. The tasks of FIG. 2 can be performed by the controller 104 under control of firmware or software executable on the controller 104.

The controller 104 receives (at 202) an indication of a voltage level change for VCC_CPU. Such indication is provided by the VID control signals (VID0, VID1, . . . , VIDn). Based on the indication of the voltage level change, the controller 104 determines (at 204) whether the processor 104 is exiting or entering the sleep state. If the processor is neither exiting nor entering the sleep state, the procedure returns to task 202.

The controller 104 also detects (at 204) a state of the FEATURE ENABLE input as set by the comparator 112. The controller 104 next determines (at 206) whether an event relating to activation or disabling of phase(s) of the multi-phase converter 103 has occurred. An event to disable phase(s) of the converter 103 is identified if the indication of voltage level change indicates that the processor 100 has entered into the sleep state, and the FEATURE ENABLE input is at the active state, which indicates that the current drawn from VCC_CPU is below a predefined threshold. An event to activate phase(s) of the converter 103 is identified if the indication of voltage level change indicates that the processor 100 has exited sleep state, or if the current being drawn from VCC_CPU exceeds the predefined threshold (which is indicated by the FEATURE ENABLE input being set at the inactive state).

In response to detecting the event to disable phase(s) of the converter 103, the controller 104 proceeds to deactivate corresponding phase control signals to disable (at 208) respective one or more phases of the converter 103. Disabling phase(s) of the converter achieves additional power savings that is in addition to power savings achieved by just placing the processor 100 into the sleep state. In alternative embodiments, to achieve power savings, instead of disabling phases of a multi-phase converter, other portions of the converter can be disabled.

In response to detecting the event to activate phase(s) at 206, the controller activates respective phase control signals to activate (at 210) the one or more phases of the converter 103 that were previously disabled. The ability to detect an event to activate phase(s) of a converter (e.g., processor exiting sleep state or processor drawing greater than a predefined current from VCC_CPU) allows for previously disabled phase(s) to be turned on in time for the expected increased power/current draw by the processor 100.

As noted above, firmware or software is executable on the controller 104 for performing various tasks according to some embodiments. The controller 104 can be implemented with a microcontroller, an application specific integrated circuit (ASIC), programmable gate array (PGA), microprocessor, and so forth. A “controller” can refer to a single component or to plural components.

Instructions of the firmware or software can be stored in a storage device, which can be implemented as one or more computer-readable or computer-usable storage media (which can be part of the controller 104).

In the foregoing description, numerous details are set forth to provide an understanding of the present invention. However, it will be understood by those skilled the art that the present invention may be practiced without these details. While the invention has been disclosed with respect to a limited number of embodiments, those skilled in the art will appreciate numerous modifications and variations therefrom. It is intended that the appended. claims cover such modifications and variations as fall within the true spirit and scope of the invention.

What is claimed is:

1. An apparatus to manage power in a system having a processor, comprising:
a voltage converter to provide a power voltage to the processor, wherein the processor is able to transition among different power modes, wherein the voltage converter is to receive indications to specify different voltage levels of the power voltage for at least two of the power modes; and
a controller to:
detect, based on the indications, a transition of the processor to a lower one of the power modes, and
in response to detecting transition of the processor to the lower one of the power, modes, disable at least one portion of the voltage converter.

2. The apparatus of claim 1, wherein the power modes comprise a sleep state and at least one performance state, wherein the lower one of the power modes comprises the sleep state, and wherein the at least one portion of the voltage converter is disabled in response to detecting transition of the processor to the sleep state.

3. The apparatus of claim 2, wherein the voltage converter is controllable in response to the indications to set the power voltage to the processor at a first voltage level for the sleep state and a second voltage level for the at least one performance state, wherein the second voltage level is greater than the first voltage level.

4. The apparatus of claim 3, wherein the indications comprise voltage control signals from the processor.

5. The apparatus of claim 4, further comprising firmware executable on the processor to set the voltage control signals to different values to cause the voltage converter to set the power voltage to the processor at the first and second voltage levels.

6. The apparatus of claim 1, wherein the voltage converter is a multi-phase converter, and wherein the disabled at least one portion of the voltage converter comprises a disabled at least one phase of the voltage converter.

7. The apparatus of claim 6, wherein the disabled at least one phase of the voltage converter comprises a disabled at least one DC-DC converter in the voltage converter.

8. The apparatus of claim 7, wherein the voltage converter includes multiple DC-DC converters corresponding to multiple phases of the voltage converter.

9. The apparatus of claim 1, wherein the controller is part of the voltage converter.

10. The apparatus of claim 1, further comprising a circuit to determine whether a current drawn by the processor from the power voltage is less than a predefined threshold,
wherein the at least one portion of the voltage converter is disabled in response to both detecting that the processor has transitional to the lower power mode and receiving an indication from the circuit that the current drawn by the processor from the power voltage is less than the predefined threshold.

11. The apparatus of claim 1, wherein the controller is to further:
detect that the processor has exited the lower power mode to a higher power mode based on the indications; and
in response to detecting that the processor has exited the lower power mode to the higher power mode, activate the at least one portion of the voltage converter that was previously disabled.

12. The apparatus of claim 1, further comprising a circuit to determine whether a current drawn by the processor from the power voltage exceeds a predefined threshold,
wherein the controller is to further activate the at least one portion of the voltage converter that was previously disabled in response to either of:
detecting that the processor has exited the lower power mode to a higher power mode; or
detecting that the current drawn by the processor from the power voltage exceeds the predefined threshold.

13. A method of power management of a processor that has a one performance state and a sleep state, comprising:
detecting that the processor has entered the sleep state by detecting an indication that a voltage level of a power voltage to the processor is being lowered to a first level, wherein the performance state of the processor is associated with the power voltage to the processor being at a second level different from the first level;
receiving an indication of current drawn by the processor; and
in response to detecting that the processor has entered the sleep state and that the current drawn by the processor is below a predefined threshold, disabling at least one phase of a multi-phase converter that supplies the power voltage to the processor.

14. The method of claim 13, further comprising:
programming the processor to define different voltage levels of the power voltage for the at least one performance power state and the sleep state.

15. A voltage converter to provide :power voltage to a processor, comprising:
a controller to:
in response to receiving indications that specify transition of voltage levels of the power voltage of the processor, detect that the processor has entered a sleep state from a performance state;
in response to detecting that the processor has entered the sleep state, disabling at least one portion of the voltage converter; and
in response to detecting that the processor has exited the sleep state, activating the at least one portion of the voltage converter that was previously disabled.
